(19) United States
(12) Patent Application Publication
(10) Pub. No.: US 2009/0223756 A1
(43) Pub. Date: Sep. 10, 2009

(54) METHOD FOR PRODUCING FRICTION SURFACES OR FRICTION LAYERS OF A CARBON-CERAMIC BRAKE DISK AS WELL AS A CARBON-CERAMIC BRAKE DISK PROVIDED WITH SUCH FRICTION SURFACES OR FRICTION LAYERS

(75) Inventor: Jens Rosenlocher, Augsburg (DE)

Correspondence Address: Novak Druce & Quigg LLP, 1300 I Street NW, Suite 1000 West Tower, Washington, DC, 20005, US

(73) Assignee: Audi AG, Ingolstadt (DE)

(21) Appl. No.: 12/398,940

(22) Filed: Mar. 5, 2009

(30) Foreign Application Priority Data
Mar. 5, 2008 (DE) 10 2008 012 683.7

(51) Int. Cl. F16D 65/12; B05D 1/02; B05D 3/08

(52) U.S. Cl. 188/218 XL; 427/422; 427/569; 427/580; 427/223; 427/576; 427/225

(57) ABSTRACT

The invention relates to a method for producing friction surfaces or friction layers in a carbon-ceramic brake disk for motor vehicles in which the friction surfaces or friction layers in the finished state are treated by a thermal coating method. The invention likewise relates to the corresponding friction surfaces or friction layers of a carbon-ceramic brake disk for motor vehicles which are produced according to such as process.

The invention relates not only to a method for producing friction surfaces or friction layers of a carbon-ceramic brake disk for motor vehicles, but also to such a carbon-ceramic brake disk whose friction surfaces or friction layers are produced according to this method.

### BACKGROUND OF THE INVENTION

Some of the carbon-ceramic brake disks available on the market have a special friction layer on their friction surfaces. This friction layer has a composition other than that of the remaining carbon-ceramic base body. This means that in the edge layers the proportion of silicon-carbide-ceramic is much higher than in the remaining base body. This measure results in the corresponding wear resistance of die friction surfaces and friction layers. In this type of production, the friction layers are applied to the base body in the so-called green state of the material, i.e., in the CFK or CFC state. This application takes place by cementing or pressing on. This bond between the base body and the friction layer is then siliconized together.

In siliconization the brake disk is infiltrated with liquid silicon at temperatures>1450° C. This process is generally carried out in a vacuum or under a protective gas.

The body which has been formed in this way and which has a different composition necessarily results in different coefficients of thermal expansion, for example, of the base body compared to the friction surfaces and friction layers. Moreover, after the siliconization process, during cooling there is the risk that thermal stresses will build up between the base body and the friction surfaces and friction layers. These types of stresses generally lead to a partially very highly pronounced, continuous, deep crack structure within the friction surfaces and friction layers. The disadvantage of such cracks is an enlarged, openly accessible structure relative to oxygen and ambient media.

A brake disk with a carbon-containing matrix material in the form of embedded carbon fibers has become known, for example, from DE 20 49 292 C3.

DE 25 40 083 A1 discloses an invention which relates to articles of carbon with an antioxidation coating over at least part of their surface. Here the carbon-containing brake disk has an antioxidation coating on at least part of its surface, this coating consisting of a silicon layer directly on the surface of the brake disk, and a nickel layer applied to this silicon layer, and of a chromium layer over the nickel layer.

In order to be able to remedy the disadvantages of the prior art, for this invention the object is to devise a wear-resistant and oxidation-resistant surface on the friction surfaces and the friction layers of brake disks for motor vehicles.

### SUMMARY OF THE INVENTION

In order to increase the service lives and thus the operating performance at a constant coefficient of friction in the friction surfaces and friction layers of a carbon-ceramic brake disk, it is proposed, according to the invention, that the friction layers be applied subsequently to the already siliconized and possibly also already finished carbon-ceramic base body. The formation of these friction layers is achieved by a method, specifically, thermal spraying. Thermal spraying can protect highly stressed, endangered surfaces or can also change them such that they withstand extremely high loads. In addition to the high load capacity, such a thermal spraying process also has the advantage that only those parts are provided with a suitable surface coating which require this surface for stress. In these thermal spraying methods there is a large number of possible combinations; this relates to use of base materials with layer materials.

### DETAILED DESCRIPTION OF THE PREFERRED EMBODIMENTS OF THE INVENTION

There are various thermal spraying methods which, however, do not compete with one another in their application, but complement one another by corresponding special properties of the methods. But all thermal spraying methods for production of the corresponding sprayed layers require two types of energy, on the one hand thermal energy, and on the other kinetic energy. The energy source is preferably a fuel gas-oxygen flame, an electric arc, a plasma jet or even a laser beam. In these methods the thermal energy is required for bringing the spray additive accordingly into the molten state in order to transport the individual particles onto the base material with kinetic energy.

As thermal spraying methods for carbon-ceramic brake disks, flame spraying with wire or rod, flame spraying with powder, high speed flame spraying, detonation spraying, plasma spraying, laser spraying, arc spraying or the like have proven to be suitable methods.

Thus, for example, in wire or rod flame spraying the additive spray material is continuously melted in the center of an acetylene-oxygen flame. By a corresponding atomizer gas, for example, compressed air or nitrogen, the droplet-shaped spray particles are detached from the molten region and sprayed or centrifuged onto the prepared material surface, in this case the friction layers or friction surfaces of the carbon-ceramic brake disk.

In another preferred method, in flame spraying with powder, a powdered spray substance is melted in an acetylene-oxygen flame and at the same time centrifuged onto the friction surface or friction layer using the expanding combustion gases.

In another preferred method, specifically, high speed flame spraying, gas is continuously burned with high pressures within a combustion chamber in which a powdered spray additive is supplied. Due to the pressure of the fuel gas-oxygen mixture which is generated in the combustion chamber and a downstream expansion nozzle, the desired high flow velocity is generated in the gas jet. In this way the spray particles are accelerated to a high particle velocity and are thus made into to a dense sprayed layer with an outstanding adhesion property.

In detonation spraying, which is likewise used as a preferred version, an acetylene-oxygen spray powder mixture is detonated by an ignition spark. The shock wave which is formed in a pipe accelerates the spray particles. The latter are heated by the flame and with high particle velocity are centrifuged in the direction to the surface of the carbon-ceramic brake disk.

In plasma spraying, likewise a preferred method, powdered spray additive is melted in or outside of the spray gun by a plasma jet and is delivered to the surface of the carbon-ceramic brake disk.

The above described thermal spraying methods which are not exhaustive can thus provide wear protection and at the same time also corrosion protection. Furthermore grain abrasion is much less than in conventional coatings. Other advantages consist in that more or less any material can be sprayed or spattered. A quite decisive factor is mat the coated material, in this case the surface of the carbon-ceramic brake disk, is not thermally altered. Here the component size and geometry are completely irrelevant since by corresponding automation the thermal spraying method is very flexible. In addition to high reproducibility, high dimensional precision and a high quality standard are ensured by these thermal spraying methods.

Thus it is possible, in addition to achieving a very good resistance to oxidation and wear, to ensure a good coefficient of friction of these layers by the corresponding choice of materials. Moreover, it becomes possible to achieve a nearly uniform coefficient of thermal expansion by the corresponding material choice, as in the carbon-ceramic base body. In subsequent operation of the brake disk this measure prevents cracks as a result of thermal stresses. By the choice of a corresponding thermal coating method the crack structure of the friction layers and friction surfaces is also clearly reduced and can be completely avoided. In particular, this measure also distinctly reduces the absorption of ambient media.

Another advantage is that due to the resistance of the thermally sprayed friction surfaces and friction layers to wear and oxidation, better operating performance of the ceramic brake disk arises; this can distinctly prolong the sen-ice intervals in particular.

The materials to be processed, for example, for ceramic, depending on the selection, can be formed, for example, from the group of silicon carbides (SiC) and silicon nitrides (SiN, Si₃N₄) or boron carbide (B₄C) or boron nitride (BN) as well as titanium carbide (TiC) or titanium nitride (TiN) or silicon oxide or zirconium oxide or compounds thereof. Compounds of these ceramics with metals such as, for example, Fe, Si, Ni, Cr, Cu, Mo are also possible.

As a result of the friction surfaces or friction layers of a carbon-ceramic brake disk being applied subsequently after siliconization or even following the finished carbide-ceramic surface, by a suitable choice of the materials to be applied, in addition to increasing the wear resistance and oxidation resistance, a good coefficient of friction can be achieved under controlled conditions. Moreover, the occurrence of cracks due to thermal stresses can be prevented since the coatings of the friction surfaces or friction layers have the same thermal behavior as the base body.

1. A method for producing friction surfaces or friction layers of a carbon-ceramic brake disk for motor vehicles, the friction layers are applied subsequently to the finished siliconized carbon-ceramic base body of the brake disk by a thermal coating method.

2. The method for producing friction surfaces or friction layers of a carbon-ceramic brake disk for motor vehicles wherein the friction layers are applied subsequently to the already siliconized carbon-ceramic base body of the brake disk by means of a thermal coating method.

3. The method according to claim 1 wherein the coating process of the friction layers is carried out by a thermal spraying method.

4. The method according to claim 1 wherein the thermal coating method is carried out by plasma spraying.

5. The method according to claim 1 wherein the thermal coating method is carried out by wire arc spraying methods.

6. The method according to claim 1 wherein the thermal coating method is carried out by a high speed flame spraying method.

7. The method according to claim 1 wherein the thermal coating method is carried out by flame spraying methods.

8. The method according to one or claim 1 wherein different materials are used in the thermal coating method for application of the friction layers.

9. The method according to one claim 1 wherein mixed ceramics are used in the thermal coating method for application of the friction layers.

10. The method according to claim 1 wherein metals are used in the thermal coating method for application of the friction layers.

11. The method according to claim 1 wherein alloys or compounds are used in the thermal coating method for application of the friction layers.

12. Friction layers of a carbon-ceramic brake disk for motor vehicles with a carbon-ceramic base body whose friction layers are produced by a method consisting of thermally coating the carbon-ceramic base body.

13. The friction surfaces or friction layers according to claim 12 wherein friction layers have nearly the same coefficients of thermal expansion as the carbon-ceramic base body used.

14. The friction layers according to claim 12 wherein friction layer has a constant coefficient of friction over operating performance.

15. The friction layers according to claim 12 wherein the friction layer is resistant to at least one of wear and oxidation.

16. A motor vehicle with carbon-ceramic brake disks whose friction layers are produced by a thermal spraying.

17. A method of producing a brake disk for a motor vehicle comprising:
forming a base body of a first ceramic material; and
forming a body of a second ceramic material on said base body by thermal spraying.

18. The method according to claim 17 wherein said thermal spraying is performed by one of a group consisting of flame spraying with wire rod, flame spraying with powder, high speed flame spraying, detonation spraying, plasma spraying, laser spraying and arc spraying.

19. A brake disk for a motor vehicle made by the process of forming a base body of a first ceramic material, and forming a second body on said base body by thermal spraying.
